(19) United States
(12) Patent Application Publication
(10) Pub. No.: US 2007/0209663 A1
(43) Pub. Date: Sep. 13, 2007

(54) Holding Device for a Respiratory Mask

(75) Inventors: Pierre-Louis Marque, Pont-Saint-Maxence (FR); Martine Boisseau, Aix en Provence (FR); Linda Rumpel, Grambois (FR); Elisabeth Fournier, Versailles (FR); Jean-Luc Godet, Antony (FR)

Correspondence Address: GREENBLUM & BERNSTEIN, P.L.C., 1950 ROLAND CLARKE PLACE, RESTON, VA, 20191, US

(73) Assignee: EQUIPEMENTS MEDICAUX ET MOYENS AVANCES-E.2.M.A (sa, La Croix Saint Ouen (FR)

(21) Appl. No.: 10/576,602

(22) PCT Filed: Oct. 22, 2004
(86) PCT No.: PCT/FR04/02710

§ 371 Date: May 18, 2007

(30) Foreign Application Priority Data
Oct. 23, 2003 (FR) 0312418

(51) Int. Cl. A62B 18/08; A62B 18/02

(52) U.S. Cl. 128/207.11; 128/207.13

(57) ABSTRACT

The present invention relates to a holding device for a respiratory mask. Said device is composed of a hub, removably fitted to the respiratory mask shells and comprising two lateral elements which allow a fin to be secured on each side of the hub, said fin comprising openings, for fastening the harness straps which are placed around the head and optionally a strap, for holding the patient's mouth closed. Said invention generally relates but is not limited to a non-invasive mechanical ventilation of airways by a gas generator, or any other medical or non-medical application, permitting the use of said device.

The present invention relates to a device for holding a respiratory mask,

It relates, in a general and non-exhaustive manner, to the field of non-invasive mechanical ventilation of airways by means of a gas generator, or any other medical or non medical application where this device can be used.

Non-invasive ventilation masks are used at home, at the hospital, or in any other location to treat patients with various pathologies, possibly respiratory pathologies, such as sleep apnea syndrome, ventilation of chronic obstructive bronchopneumopathy (COBP) or restrictive pulmonary pathologies in the adult or the newborn.

Non-invasive ventilation (NIV) is contrary to invasive ventilation. The latter requires a light surgery, which enables the ventilation of the patient's lungs by means of a tracheotomy. Numerous medical practices using invasive artificial ventilation are now replaced by the NIV, markedly less traumatic for the patient and substantially less expensive, while reducing the risks related to any surgical intervention.

The large majority of industrial, non-invasive ventilation masks includes nasal shells with standardized dimensions with a vertical extension ending at the forehead with a wide holding surface, a shell-skin interface and a headband or harness for holding the mask on the patient's face.

The use of a ventilation mask during a mechanical ventilation, with or without leakage, implies the possible connection of a coupling, some accessories, and one or several pressurized air inlet pipes. These devices generate forces that either tilt the mask forward or turn it upward. The solution envisioned in the design of conventional and custom-built masks lies in fixing a harness directly connected to the mask shelf at various points. The existing fixing methods are mainly achieved by means of either a strap passing through openings molded with the mask, or clips.

The object of the device according to the instant invention is an interface adapted to a shell of a non-invasive ventilation (NIV) mask, volumetric or barometric, with or without leakage, that solves the tilting or turning constraints related to nasal shells deprived of frontal extension in order to clear the patient's field of vision of any element that is capable of blocking it.

Besides its bio-compatibility, the object of the invention offers multiple advantages with respect to known embodiments:
Holding comfort on the patient's skin
Optimal elimination of the linkages related to pressure existing in the patient's mask.
It sustains high temperatures for advanced disinfection.
It sustains all of the cleaning and disinfecting products and equipment usually available to user services.
It frees the patient's field of vision.
It facilitates the wear of glasses,
It is neither glued nor clipped to the shell of the mask and is easily affixed to or separated from the latter.

It is made of a hub removably fitted to the respiratory mask shells and comprising two lateral elements that makes it possible to attach, on each side of the hub, a fin comprising openings for fastening the harness straps that are positioned around the head, and optionally a strap for keeping the patient's mouth closed.

In the annexed drawings, given as non-limiting examples of embodiments according to the instant application;

FIG. 1 shows a side view of an alternative embodiment of the device mounted on the patient's head,

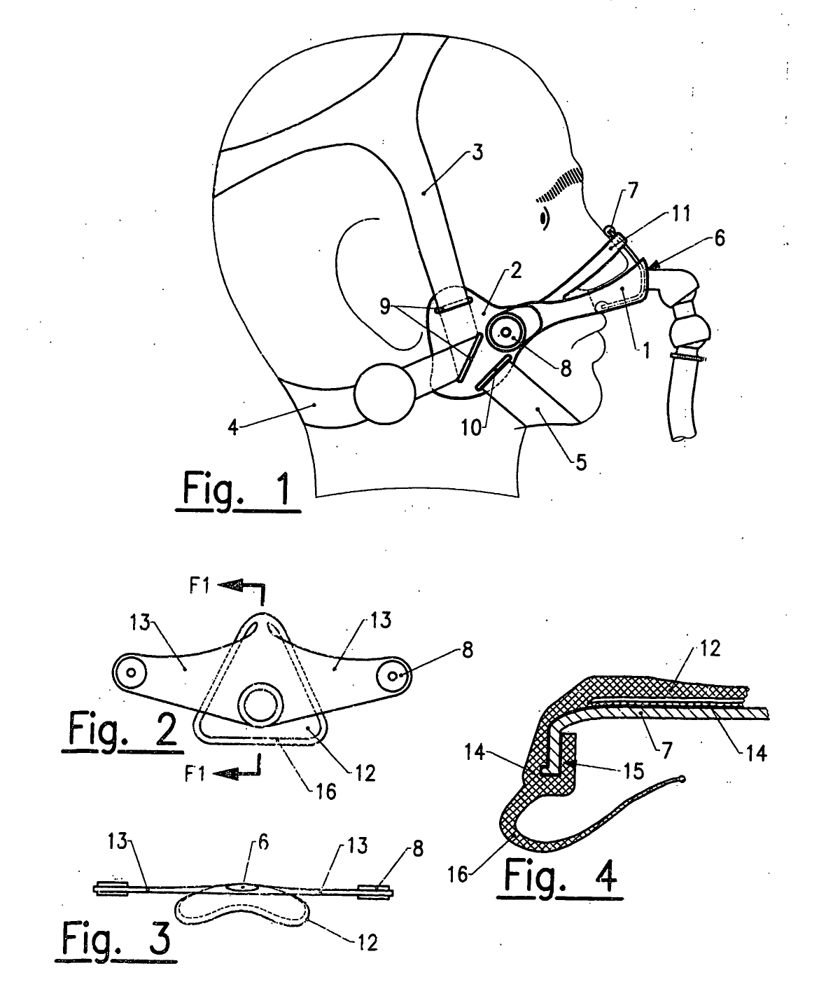

FIG. 2 shows a top view of another alternative embodiment of the hub,

FIG. 3 shows a side view of the same alternative embodiment,

FIG. 4 shows an enlarged transverse cross-section along the arrows F1 of FIG. 2,

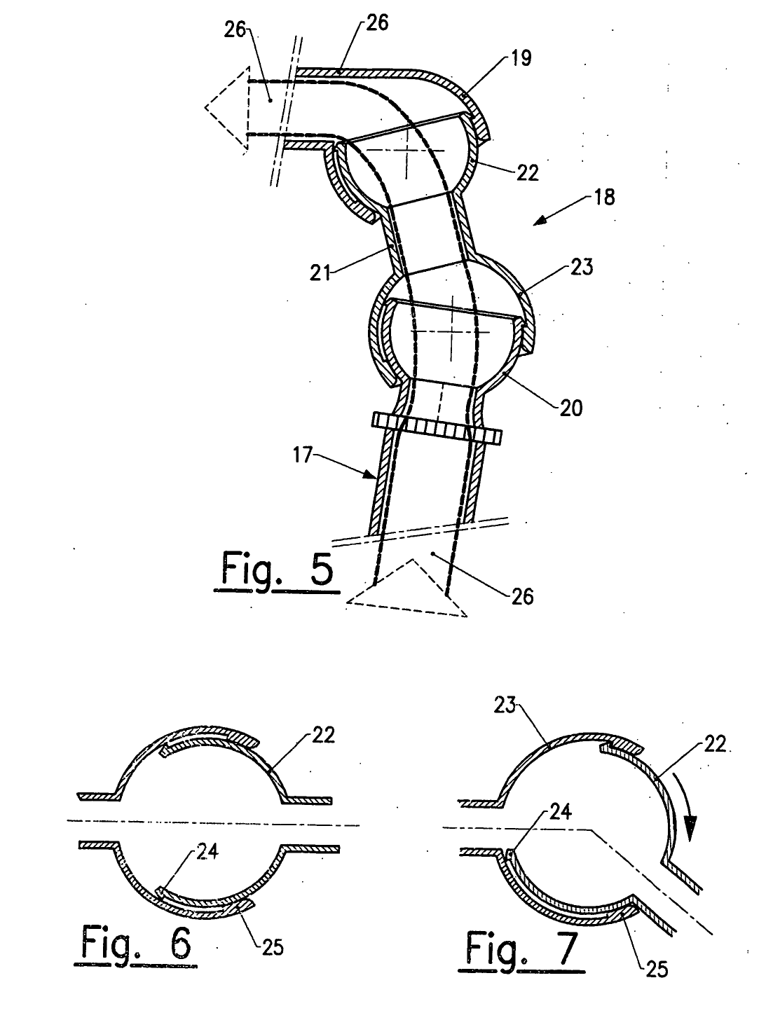

FIG. 5 is a longitudinal cross-section of a gas-feeding coupling system provided with a ball and socket joint,

FIG. 6 and 7 show a cross-sectional view of a ball and socket joint in two different positions.

The device, FIGS. 1 to 4, includes a universal hub 1 positioned on the pressurized air inlet device of the mask and two lateral removable fins 2 mounted at the right and left of the hub and enabling the straps 3, 4 of the holding harness to be fixed, and the immobilization strap adapted to keep the patient's mouth closed.

The hub 1, called “butterfly” (“DigiWing”), is adapted to be mounted on the generally cylindrical air inlet 6 of the mask shell 7. At the two ends of the hub are positioned fixing elements 8 of the snap-fastener type, or any other simple and fast unfastening system having an articulation with a balance point to which two fins, right and left, are laterally “clipped”, on each of which openings 9, 10 are arranged in which are fastened or slide:
the straps 3, 4 of the harness positioned around the head,
the immobilization strap 5 keeping the patient's mouth closed.

In FIG. 1, the upper portion of the “butterfly” is constituted of a strap 11 which can be either rigid and integral with the hub, or made of a strap of a translucent or non-translucent, elastic, plastic material, which is retained at the ends. The object of this strap is to be the main element in the high retention of the mask to avoid the frontward tilting during a substantial tension caused by the mask's pressurized air inlet pipes and other accessories connected to the feed circuits,

Fastening the fins 2 by means of elements of the “snap-fastener type” or similar offers several advantages that are not found in the conventional systems when the patient's head moves.

Indeed, in these systems, the mask shell 7 is affixed to the harness. All the constraints from the latter are automatically passed on to the patient's face by a movement of the shell, which is a source of annoyance and presents a risk of leakages.

Conversely, with the system according to the invention, the constraints linked to these movements are passed on to the fins 2 and to the hub 1. These absorb them due to the rotation of the “clipping” of the fins to the hub, on the one hand, and to the rotation of the hub on the air inlet 6, on the other hand.

All of these movements do not cause any constraint on the patient shell 7, the latter not being affected by the movements and always remaining in the same optimum position.

The opening of the harness to free the mask is carried out solely by separating one of the right or left fins 2.

The hub 1 and the fins 2 are preferably made of a material that is compatible with a short-term or long-term use.

This hub is either thermoformed on PETG polyester or any other material having similar properties, or made from a mold, and withstands the constraints linked to the cleaning and sterilizing procedures.

According to an alternative embodiment, the hub 1′ can advantageously be made of three affixed elements (FIGS. 2, 3 and 4):
an upper veil 12 with an outer device provided with two lateral extensions 13 serving as a base for the fixing of the harness,
an intermediary, supple and elastic veil fabric in which the mask shell 7 is positioned, which is inserted through the base and positioned in an L-shaped groove 15 along the base of the outline,
a peripheral contact lip 16 adapted to take support on the patient's skin.

When the mask shell 7 is inserted in the hub 1′, it forcibly pushes the intermediary veil 14 toward the top, this veil therefore extends over the entire surface of the shell. Then, the user positions the ends of the shell in the groove. The lip 16 automatically adjusts to the mask outline due to the tension provided by the veil.

This hub 1′ is made of silicone or any other material of medical quality for a long-term use (FIGS. 2 and 3). The elasticity of this material makes it possible to make a single hub model fitting any respiratory mask shells, whatever their size.

This device is particularly designed for mounting respiratory mask shells 7 that are custom-built by means of an acquisition procedure in three dimensions (“3D”), digital, or non digital, recording the relief and the depressions of the patient's face, and used for making, by means of a digitally-controlled machining system for making a mold representing the inner or outer shell print and making it possible to form the latter by thermoforming a synthetic sheet of material. This shell is preferably designed to enclose only the nose round tip and the nostrils.

The digital file or files that are obtained are modeled by means of a computer-assisted design software to make the mold by means of a step-by-step digitally-controlled machining system. This or these file(s) can be transferred to the memory of a standard home computer or laptop equipped with a graphics cord and a modem, then transmitted via the internet, or another telematic network, to a file exploitation site for making the masks.

The computer-assisted design software is advantageously arranged to automatically take into account the specific morphology of each facial shape, whether it is human or not.

The described system is preferably connected to the pressurized gas-feeding pipe 17 by a coupling having a ball-and-socket joint 18.

The assembly is essentially made of a female ball and socket joint 19 and a male ball and socket joint 20, one mounted on the respiratory mask, the other at the end of a feeding pipe 17, both comprising a substantially cylindrical joint that can be funnel-shaped to allow for the connecting and disconnecting of couplings having varying diameters. To improve the articulation movement, one can advantageously provide at least one intermediary cylindrical coupling sleeve 21 including two spherical elements 22, 23, male and female respectively, so as to allow for a vertical clearance angle of at least 90° (FIG. 5). In particular, this system decreases the traction effects produced by all the fixed element located before the joint.

The three elements hereinabove are each made of a single piece, made of molded plastic material that does or does not withstand the temperature constraints or other chemical procedures related to the sterilization, or other material and arranged to allow for the mounting of the ball-and-socket joints by forcible nesting.

The generally cylindrical ducts that are butt-joined in the ball-and-socket joints must not be partially obstructed in order to limit any form of restriction in the passage of gas, downstream as well as upstream. For this purpose, the ball-and-socket joints clearance is limited by means of an annular lock pin 24 of the male portions taking support on an inner annular abutment 25 of the female portions (FIGS. 6 and 7). A fictitious cylinder 26 extending through all of the ball-and-socket joints must thus be formed, providing a virtual air flow channel having no restriction, whatever the inclination of the ball-and-socket joints.

The butt-joining cylinder 26 of the ball-and-socket joint 19 can advantageously have a position that is tangential to the female ball-and-socket joint in order to outwardly offset the center of gravity. This position facilitates the rotation of all of the ball-and-socket joints toward an equilibrium position, minimizing the forces in order to do so (FIG. 5).

The device according to the invention, due to its composition and design, enables its arrangement on the shells of the patients mask, whatever their size.

The positioning of the various constitutive elements gives the object of the invention a maximum of useful effects that until now, not been achieved by similar devices.

1. Device for retaining a respiratory mask adapted to be used mainly in the field of non-invasive mechanical ventilation of airways, whether in a hospital, at home or in any other location where non-invasive mechanical ventilation is used, or for any other medical or non-medical application, this device comprising in particular a hub (1, 1′) for receiving the shell (7) of the mask, characterized in that the hub (1, 1′) comprises at each of its two lateral ends, fixing elements (8) of the simple and fast unfastening snap-fastener type, having an articulation with a balance point on which are two laterally “clipped” right and left fins (2) on which are fixed straps (3, 4) of the harness positioned around the head, as well as the immobilization strap (5) for holding the patient's mouth closed, on the one hand, and in that the upper portion of the hub (1) is constituted of a strap (11) fixed at its ends and arranged to ensure the high retention of the mask so as to avoid frontward tilting during a substantial tension caused by the air inlet pipes of said mask and other accessories connected to the feed circuits.

2. Device according to claim 1, characterized in that the hub (1′) is constituted of three affixed elements; first an upper veil (12) with two lateral extensions (13) for fixing the harness then, an intermediary, supple and elastic veil (14) receiving the mask shell (7) inserted through the base and positioned in an L-shaped groove (15) along the base of the outline and, lastly, a peripheral contact lip (16) adapted to take support on the patient's skin.

3. Device according to claim 2, characterized in that the hub (1′) is arranged so as to be capable of adapting to any respiratory mask shells, whatever their size.

4. Device according to claim 1, characterized in that the hub (1′) is made of medical quality silicone enabling a long-term use.

5. Device according to claim 1, characterized in that the hub (1) and the fins (2) are made by thermoforming PETG polyester or any other material having similar properties, or molding.

6. Device according to claim 2, characterized in that the hub (1, 1′) is designed to allow for the mounting of respiratory mask shells (7) that are custom-built by an acquisition procedure in three dimensions (“3D”), digital or non-digital, recording the reliefs and the depressions of the patient's face, and used for making, by means of a digitally-controlled machining system, a mold representing the inner or outer shell print.

7. Device according to claim 6, characterized in that the mask shell (7) used is made by modeling the digital file or files that are obtained by means of a computer-assisted design software to make a mold by means of a step-by-step digitally-controlled machining system, which makes it possible to form the shell by thermoforming a sheet of synthetic material.

8. Device according to claim 7, characterized in that the computer-assisted design software is arranged to automatically take into account the specific morphology of each facial shape.

9. Device according to claim 7, characterized in that the mask shell is made by transferring the digital file(s) to the memory of a standard home computer or laptop equipped with a graphics cord and a modem, then transmitted via the Internet, or another telematic network, to a file exploitation site for making the masks.

10. Device according to claim 1, characterized in that the mask shell (7) is connected to a pressurized gas-feeding pipe (17) by means of an articulated coupling (18) having a ball-and-socket joint.

11. Device according to claim 10, characterized in that the articulated coupling (18) comprises a female ball-and-socket joint (19) and a male ball-and-socket joint (20), one mounted on the respiratory mask, the other at the end of the gas-feeding pipe (17), both comprising a substantially cylindrical joint that can be funnel-shaped to allow for connecting and disconnecting couplings having a varying diameters.

12. Device according to claim 11, characterized in that the articulated connection (18) comprises at least one intermediary cylindrical coupling sleeve (21) comprising two spherical elements (22, 23), male and female respectively.

13. Device according to claim 10, characterized in that the clearance of the ball-and-socket joints of the articulated connection is limited by an annular lock pin (24) of the male portions taking support on an inner annular abutment (25) of the female portions so as to prevent the generally cylindrical ducts butt-joined in the ball-and-socket joints from being obstructed, even partially.

14. Device according to claim 10, characterized in that the articulated connection (18) is designed to allow for a vertical clearance angle equal to or greater than 90°.

15. Device according to claim 10, characterized in that the female ball-and-socket joint (1 9), the male ball-and-socket joint (20), and the intermediary coupling sleeve(s) (21) are each made of a single piece arranged to enable the mounting of the ball-and-socket joints by forcible nesting.

16. Device according to claim 15, characterized in that the female ball-and-socket joint (19), the male ball-and-socket joint (20), and the intermediary coupling sleeve(s) (21) are made of molded plastic material.
